(19) United States
(12) Patent Application Publication
(10) Pub. No.: US 2017/0274400 A1
(43) Pub. Date: Sep. 28, 2017

(54) Nozzle Wear Out Detection System

(71) Applicant: CNH Industrial Canada, Ltd., Saskatoon (CA)

(72) Inventor: Trevor Kowalchuk, Saskatoon (CA)

(21) Appl. No.: 15/082,487

(22) Filed: Mar. 28, 2016

(51) Int. Cl. B05B 12/00; G01F 1/66

(52) U.S. Cl. CPC B05B 12/008; G01F 1/666; A01C 23/047

(57) ABSTRACT

With the use of low cost microphones mounted near each nozzle, sound signatures of the nozzles may be captured and compared to a baseline calibration measurement corresponding to a substantially new nozzle to determine if the nozzle is worn out. Sound signatures may be periodically captured and compared to the baseline calibration measurement to provide a continuous indicator of wear out for each nozzle. The invention has the advantage of being relatively low cost with ceramic microphones, for example, and with little or no moving parts required.

### FIELD OF THE INVENTION

The present invention relates generally to agricultural sprayers, and in particular, to spray nozzle assemblies having microphones nearby for determining spray nozzle assembly wear out.

### BACKGROUND OF THE INVENTION

Field sprayers, as known in the art, are typically attached to, or towed by, an agricultural implement such as a tractor or other vehicle, or are a dedicated self-propelled sprayer vehicle. Such sprayers generally include a fluid holding tank supported by a frame. The fluid holding tank typically stores a crop protection fluid, such as pesticides or liquid fertilizer, which often consists of a carrier fluid (such as water) mixed with a chemical at a predetermined concentration. The fluid holding tank, in turn, is fluidly coupled to a series of spray nozzles spaced apart from one another along booms extending outwardly from the frame. Accordingly, the crop protection fluid may be dispensed through the spray nozzles onto the farm field, preferably in an even distribution spray pattern, so that the fluid is applied consistently across the farm field.

In some situations, the outlet of spray nozzles (orifices) may become worn out, thereby causing an undesirable increase in fluid flow (or undesirable loss of pressure at the same fluid flow) and/or irregular spray patterns at the spray nozzle outlet. This may result in a wasteful distribution of excess fluid and/or an inefficient distribution of fluid on the agricultural field. Consequently, what is needed is a low cost way to accurately determine when a particular spray nozzle has worn out and therefore requires replacement.

### SUMMARY OF THE INVENTION

With the use of low cost microphones mounted near each nozzle, sound signatures of the nozzles may be captured and compared to a baseline calibration measurement corresponding to a substantially new nozzle to determine if the nozzle is worn out. Sound signatures may be periodically captured and compared to the baseline calibration measurement to provide a continuous indicator of wear out for each nozzle. The invention has the advantage of being relatively low cost with ceramic microphones, for example, and with little or no moving parts required.

Accordingly, an acoustic system may utilize a microphone and flow meter to monitor a sprayer tip. A computer implemented algorithm may mark a baseline of when the tip is new, and may compare that baseline signature periodically to a current signature to “listen” for when a tip has worn out. A worn out tips will change the acoustic signature of an individual tip for detection. This may provide a wear out detection technique for each individual tip, and not merely a wear out detection technique at a whole system or zone level granularity.

Specifically then, one aspect of the present invention provides a nozzle flow detection system including: a spray nozzle assembly providing an outlet for discharging fluid; a microphone positioned near the outlet, the microphone being configured to communicate acoustic data corresponding to a discharge of fluid at the outlet; a data structure holding a baseline calibration measurement corresponding to a discharge of fluid at the outlet, the baseline calibration measurement being derived from acoustic data provided by the microphone at an initial time; and a controller in communication with the microphone and the data structure, the controller being configured to receive a flow measurement corresponding to a discharge of fluid at the outlet, the flow measurement being derived from acoustic data provided by the microphone at a subsequent time. The controller may compare the flow measurement to the baseline calibration measurement to determine an error.

Another aspect of the present invention may provide a method for determining a worn spray nozzle assembly including: (a) discharging fluid from an outlet of a spray nozzle assembly; (b) holding a baseline calibration measurement corresponding to a discharge of fluid at the outlet, the baseline calibration measurement being derived from acoustic data provided by a microphone at an initial time; (c) receiving a flow measurement corresponding to a discharge of fluid at the outlet, the flow measurement being derived from acoustic data provided by the microphone at a subsequent time; and (d) comparing the flow measurement to the baseline calibration measurement to determine an error at a subsequent time.

Another aspect of the present invention may provide a self-propelled sprayer including: an operator cab supported by a chassis; a wing boom supporting by the chassis, the wing boom including multiple spray nozzle assemblies, each spray nozzle assembly providing an outlet for discharging fluid; multiple microphones, each microphone being positioned proximal to an outlet, each microphone being configured to communicate acoustic data corresponding to a discharge of fluid at an outlet; a data structure holding multiple baseline calibration measurement corresponding to a discharge of fluid at an outlet, the multiple baseline calibration measurement being derived from acoustic data provided by the multiple microphones at an initial time; and a controller in communication with the multiple microphone and the data structure, the controller being configured to receive flow measurements corresponding to a discharge of fluid for each of the multiple spray nozzle assemblies, the flow measurements being derived from acoustic data provided by the multiple microphone at a subsequent time. The controller may compare the flow measurements to the multiple baseline calibration measurements to determine multiple errors, and multiple errors may indicate multiple worn spray nozzle assemblies.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 illustrates a pictorial view of a spraying system in accordance with the present invention;

FIG. 2 illustrates a pictorial view of a spray nozzle assembly in accordance with the present invention;

FIG. 3 illustrates a schematic view of a nozzle flow detection system in accordance with the present invention;

FIG. 4 illustrates a pictorial view of a microphone provided in the nozzle flow detection system of FIG. 3;

FIG. 5 illustrates a baseline calibration measurement which may be derived from acoustic data provided by a microphone near a substantially new spray nozzle assembly at an initial time;

FIG. 6 illustrates a flow measurement which may be derived from acoustic data provided by a microphone near a spray nozzle assembly at a subsequent time;

FIG. 7 illustrates a flow chart of the nozzle flow detection system in accordance with the present invention; and

FIG. 8 illustrates a pictorial view of an alternative spraying system in accordance with the present invention.

### DETAILED DESCRIPTION OF THE DRAWINGS

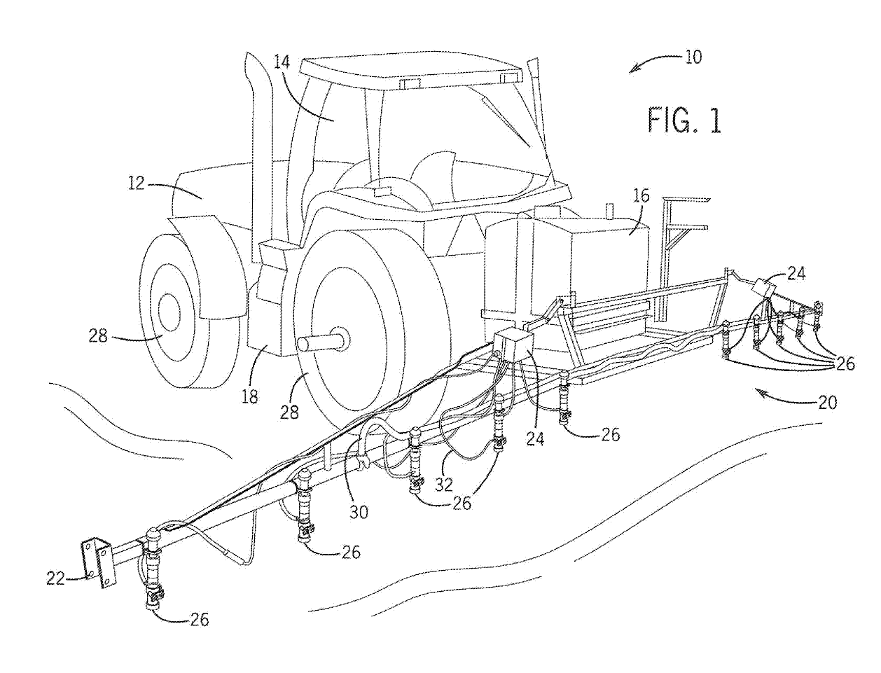

Referring generally to the drawings, and more particularly to FIG. 1, an exemplar agricultural product application system, which in the illustrated embodiment is a field spraying system 10 (a tractor with a three point mounted sprayer attached), is shown in accordance with the present invention. The field spraying system 10 may comprise a self-propelled sprayer 12 having an operator cab 14 and a primary fluid tank 16 supported by a chassis 18. A rear end 20 of the chassis 18 may support a wing boom 22 (or multiple wing booms) to which one or more secondary fluid tanks, which could be provided as illustrated by reference numeral 24, may be supported. The wing boom 22 also supports a series of spray nozzle assemblies 26 for spraying an area of a field. The chassis 18 is supported by a set of wheels 28, and the wing boom 22, depending on size, may be supported by a set of smaller wheels (not shown).

Primary distribution lines 30 are flow coupled between the primary fluid tank 16 and the spray nozzle assemblies 26. The primary fluid tank 16 may typically store a carrier fluid such as water. The primary distribution lines 30 may provide flow of the carrier fluid to the spray nozzle assemblies 26 directly or indirectly, such as via one or more charge pumps, accumulators, control valves, pressure relief valves, manifolds and/or supplemental distribution lines in the path as understood in the art for effecting various flow rates, pressures and control for sprayer configurations.

Secondary distribution lines, which could be provided as illustrated by reference numeral 32, may be flow coupled between one or more of the secondary fluid tanks 24 and the spray nozzle assemblies 26. The secondary fluid tanks 24 may typically store a chemical fluid, such as a liquid fertilizer, pesticide, herbicide, or the like. The secondary distribution lines 32 may provide flow of the chemical fluid to the spray nozzle assemblies 26 directly or indirectly, such as via one or more charge pumps, accumulators, control valves, pressure relief valves, headers, manifolds and/or supplemental distribution lines in the path as understood in the art for effecting various flow rates, pressures and control for sprayer configurations. Accordingly, the carrier fluid and the chemical fluid may be stored in different tanks and subsequently mixed at each of the spray nozzle assemblies 26 thereby providing improved distribution in the field. The secondary fluid tanks 24 are typically smaller than the primary fluid tank 16.

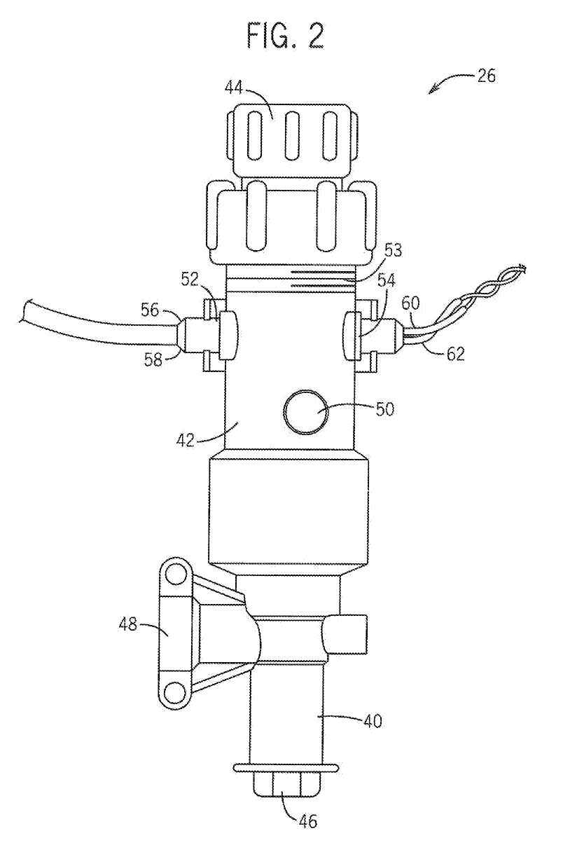

Referring now to FIG. 2, in a spray system, a pictorial view of an exemplar spray nozzle assembly 26 is provided in accordance with the present invention. The spray nozzle assembly 26 may generally include a nozzle body 40, coupled in turn to a mixing body 42, coupled in turn to a control valve 44. In one aspect, the nozzle body 40 may be thread coupled to the mixing body 42, and the mixing body 42 may be thread coupled to the control valve 44, although other temporary or permanent coupling techniques known, in the art could be used, such as pressure fittings and/or adhesive agents.

The nozzle body 40 includes a nozzle outlet 46 (exposing an orifice) for spraying a mixed fluid which will typically consist of a carrier fluid (such as water) mixed with a chemical fluid at some concentration. The nozzle body 40 may also include a nozzle body inlet 48 for receiving the carrier fluid. The carrier fluid may come from the primary fluid tank 16 via the primary distribution lines 30.

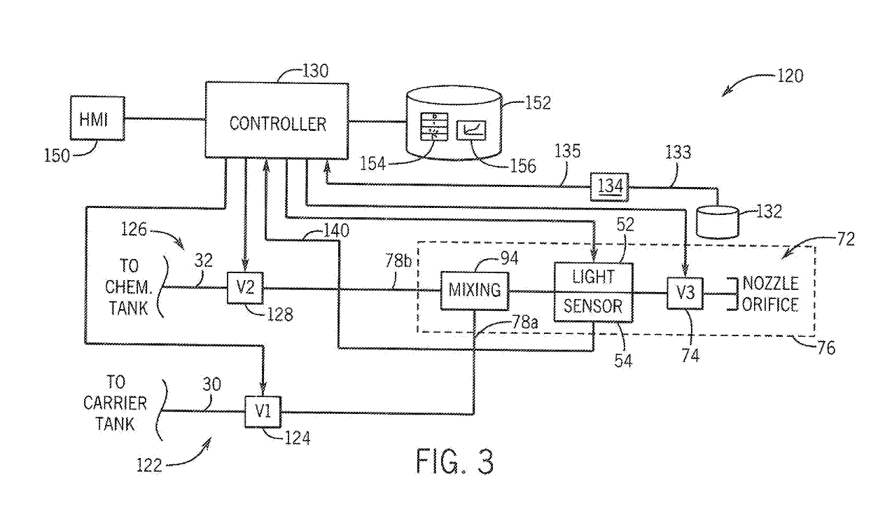

The mixing body 42 may include a mixing body inlet 50 for receiving the chemical fluid (such as a liquid fertilizer, pesticide, herbicide, or the like). The chemical fluid may come from either of the secondary fluid tanks 24 via the secondary distribution lines 32. Within the mixing body 42, a flow control mechanism (shown in FIG. 3) may provide a mixing chamber for mixing the carrier fluid with the chemical fluid in the nozzle to provide the mixed fluid.

The control valve 44 may operate to stop the mixed fluid from flowing to the nozzle outlet 46, or to allow the mixed fluid to flow to the nozzle outlet 46 for spraying.The control valve 44 could be a passive check valve, as shown in FIG. 2, in which the mixed fluid is mechanically stopped from flowing if there is insufficient pressure applied by the mixed fluid against a valve mechanism, or the mixed fluid is allowed to flow if there is a build-up of sufficient pressure of the mixed fluid against the valve mechanism. Alternatively, the control valve 44 could be an actively controlled solenoid valve, as shown in FIG. 3 by reference numeral 74, in which the mixed fluid is stopped from flowing or allowed to flow depending on a control, signal provided to a solenoid which actuates a valve. Accordingly, the control valve 44 may serve to prevent undesirable leaking of the mixed fluid. Also, the control valve 44 may be operator or computer controlled in the field.

Still referring to FIG. 2, an optional light source 52 and light sensitive receiver 54 may each be connected to the spray nozzle assembly 26. The light source 52 and the light sensitive receiver 54 may be contained in separate housings, and each of the housings may fit in opposing openings of the mixing body 42 with fluid tight seals. The light source 52 may be any circuit, element or device for emitting light in the mixing body, and may preferably be a Light Emitting Diode (LED). First and second light source signals 56 and 58, respectively, may interface with other control systems or circuitry of the field spraying system 10 and may allow for turning on or off the light source 52, biasing, and/or controlling the intensity, brightness and/or wavelength of light produced by the light source 52.

The light sensitive receiver 54 may be any circuit, element or device for receiving light in the mixing body and generating an electrical signal indicating an amount of light received by the light sensitive receiver 54. The light sensitive receiver 54 may preferably be a photodiode. In particular, the light sensitive receiver 54 may receive light from the light source 52 (passing through the mixed fluid) within the mixing body 42. First and second light sensitive receiver signals 60 and 62, respectively, may interface with other control systems or circuitry of the field spraying system 10 and may allow for sending an electrical signal indicating the amount of light received by the light sensitive receiver 54, biasing, and/or controlling the wavelength of light to which the light sensitive receiver 54 may be sensitive.

In sending the electrical signal indicating the amount of light received, one of the first and second light sensitive receiver signals 60 and 62, respectively, could be used to provide an analog voltage having a magnitude in proportion to the amount of light received by the light sensitive receiver 54, while the other of the first and second light sensitive receiver signals 60 and 62, respectively, could provide a reference level. In an alternative aspect, digital circuitry could be employed in the light sensitive receiver 54 so that the first and/or second light sensitive receiver signals 60 and/or 62, respectively, provide a digital representation of the magnitude of light received. Alternative aspects may provide varying types of spray nozzle assemblies within the scope of the invention.

Referring now to FIG. 3, a schematic view of a nozzle wear out detection system,shown as nozzle flow detection system 120, is provided in accordance with the present invention. A first distribution path 122 may be provided for distributing a first fluid, which may be a carrier fluid stored in the primary fluid tank 16. The first distribution path 122 may receive the carrier fluid via the primary distribution line 30, and may include a first electronically controlled valve 124 (identified as “V1”), which may be a solenoid valve operating in a manner similar to the solenoid control valves described above with respect to FIG. 3, for metering the carrier fluid to the spray nozzle assembly 76 (and to the mixing chamber 94).

A second distribution path 126 may be provided for distributing a second fluid, which may be the chemical fluid stored in the secondary fluid tank 24. The second distribution path 126 may receive the chemical fluid via the secondary distribution line 32. The second distribution path 126 preferably distributes the chemical fluid at a higher pressure than the first distribution path 122 distributing the carrier fluid. The second distribution path 126 may include a metering system which may consist of a second electronically controlled valve 128 (identified as “V2”).

A controller 130 may be configured, among other things, to control the first and second electronically controlled valves 124 and 128, respectively. The controller 130 may be a microprocessor, a microcontroller or other programmable logic element as known the art.

The first and second distribution paths 122 and 126, in turn, may be coupled to a spray nozzle assembly 76 (and the mixing chamber 94), such that the chemical fluid and the carrier fluid may be mixed to produce the mixed fluid. The spray nozzle assembly 76, in turn, provides a nozzle outlet 72 (orifice) for discharging the mixed fluid. The spray nozzle assembly 76 may include a third electronically controlled valve 74 (identified as “V3”) for controlling flow of the mixed fluid between the mixing chamber 94 and the nozzle outlet 72, and the controller 130 may be further configured to control the third electronically controlled valve 74.

In an alternative arrangement, the chemical fluid and the carrier fluid may be mixed earlier upstream, including being premixed in combined bulk tank, with a single distribution path provided to the spray nozzle assembly as understood the art (instead of separate chemical and carrier tanks with separate distribution paths). Also, although only a single metering system and spray nozzle assembly 76 is shown in FIG. 5 (identified as “n”) for ease of understanding, it will be appreciated that the nozzle flow detection system 120 will typically include numerous spray nozzle assemblies 76, and perhaps numerous metering systems, as provided in the field spraying system 10.

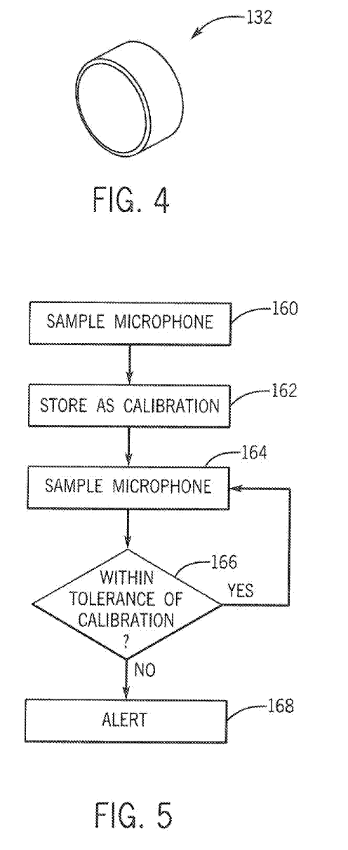

Still referring to FIG. 3, a microphone 132 may be positioned proximal to the nozzle outlet 72 of the spray nozzle assembly 76, such as within a few centimeters. The microphone 132, illustrated by way of example in FIG. 4, could be a low cost ceramic microphone, such as a 9.7 mm, noise cancelling, terminal mount, 1.5 V DC, electriccondenser microphone as available from CUI Inc. of Tualatin, OR under part no. CMP-5247TF-K. The microphone 132 may be configured to communicate acoustic data 133 corresponding to a discharge of fluid at the nozzle outlet 72. The microphone 132 may be coupled to circuitry 134 for providing signal conditioning and/or processing which, in turn, is provided to the controller 130. Alternatively, the microphone 132 couldbe coupled directly to the controller 130, and the controller 130 could be configured to provide such signal conditioning and/or processing. As a result, a measurement 135, derived from the acoustic data 133 provided by the microphone 132, is ultimately received by the controller 130.

Within the spray nozzle assembly 76, between the mixing chamber 94 and the third electronically controlled valve 74, the mixed chemical and carrier fluids (i.e., mixed fluid) may pass through an optional fluid inspection region in which the light source 52 transmits light through the mixed fluid to the light sensitive receiver 54 to produce a feedback signal 140 to the controller 130. The feedback signal 140 may indicate a concentration of the chemical fluid in the mixed fluid.

The controller 130 may also be in communication with a Human Machine Interface (HMI) 150 and a data structure 152. The HMI 150 may consist of a graphical display, such as a touchscreen monitor, warning lights, keyboard and/or other I/O positioned in the operator cab 14. The data structure 152 may include a table, database and/or other objects stored in a non-transient computer readable medium, such as a mass storage device or memory. The data structure 152 may hold a first data set 154 consisting of baseline calibration measurements for the spray nozzles (0 to n), each corresponding to discharge of fluid at respective nozzle outlets 72. In one aspect, the first data set 154 may consist of a predetermined baseline calibration measurement for a substantially new nozzle outlet which may be implemented in the system. In another aspect, the first data set 154 may consist of multiple baseline calibration measurements for particular nozzle outlets in the system which may be sampled in the system when the nozzle outlet are substantially new (or initially deployed). The data structure 152 may hold a second data set 156 consisting of correlation data for the spray nozzles, in one aspect correlating frequency response (Hertz) with volumetric throughput (liters per minute).

Referring also to FIG. 5, in one aspect of operation, the controller 130 may receive baseline calibration measurements, via acoustic data from the microphones 132, with each of the spray nozzle assemblies 76 of the field spraying system 10 fully on with the nozzle outlets 72 each spraying the mixed fluid (step 160). This may correspond, for example, to when spray nozzle assemblies 76 are substantially new (or initially deployed). The controller 130 may then store such baseline calibration measurements in the first data set 154 of the data structure 152 (step 162). In an alternative aspect, one or more predetermined baseline calibration measurements for substantially new nozzle assemblies, which may be implemented in the system, may be stored in the first data set 154 of the data structure 152 (step 162)

Next, the controller 130 may subsequently receive flow measurements (or sound signatures), via acoustic data from the microphones 132, with each of the spray nozzle assemblies 76 of the field spraying system 10 turned on (step 164). These flow measurements may occur, for example, while spraying in the field.

In decision step 166, the controller 130 compares each of the flow measurements to each of the respective calibration measurements to determine an error for each of the spray nozzle assemblies 76. If the error for each of the spray nozzle assemblies 76 is within a predetermined tolerance, such as a flow measurement being within ±10% of a respective baseline calibration measurement, the process may periodically return to step 164 and repeat. However, if the error for any of the spray nozzle assemblies 76 exceeds a predetermined tolerance, such as a flow measurement exceeding ±10% of a respective calibration measurement, the controller 130 may generate an alert (step 168). Moreover, the alert may be visually displayed to an operator of the field spraying system 10, such as via the HMI 150, and the alert may indicate which spray nozzle assembly 76 exceeded the tolerance.

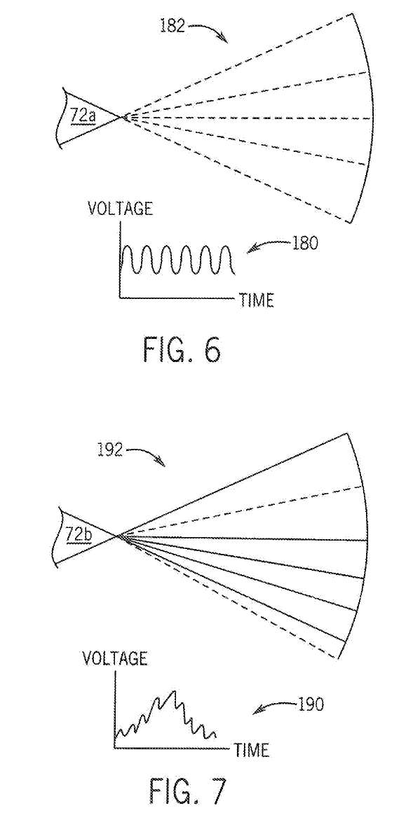

Referring now to FIG. 6, a baseline calibration measurement 180 is illustrated by way of example. The baseline calibration measurement 180 may be derived from acoustic data provided by the microphone 132 near a substantially new nozzle outlet 72a of a spray nozzle assembly. Being substantially new or initially deployed, at an initial time, the new nozzle outlet 72a may produce a substantially uniform spray pattern 182 of fluid at a desired pressure. Acoustic data provided by the microphone at this initial time may produce the baseline calibration measurement 180, which may be a periodic waveform having a fixed amplitude. This may correspond, for example, to steps 160 and 162 of FIG. 5.

However, due to excessive wear over time, a flow measurement 190 corresponding to a discharge of fluid at a worn outlet 72b of a spray nozzle assembly may appear substantially different as shown in FIG. 7. The flow measurement 190 may be similarly derived from acoustic data provided by the microphone 132 near the worn outlet 72b. Being substantially worn, at a subsequent time, the worn outlet 72b may produce an irregular spray pattern 192 of fluid with solid lines denoting heavy streams. Acoustic data provided by the microphone at this subsequent time may produce the flow measurement 190, which may be an erratic waveform. This may correspond, for example, to a flow measurement exceeding a predetermined tolerance of decision step 166, thereby generating an alert in step 168, in FIG. 5.

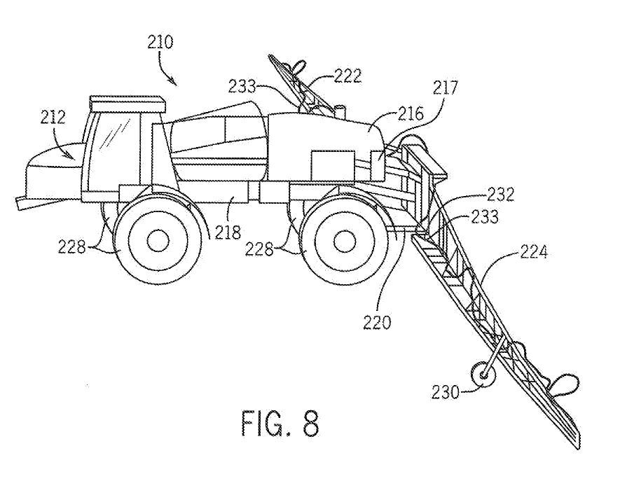

Referring now to FIG. 8, a pictorial view of an alternative spraying system is provided in accordance with the present invention. A field spraying system 210 may be comprised of a self-propelled sprayer 212 having primary and secondary fluid tanks 216 and 217, respectively, that are supported by a chassis 218 in a known manner. As also known in the art, a rear end 220 of the chassis 218 may supports a pair of wing booms 222, 224 to which a series of the spray nozzle assemblies (not shown) may be coupled. The chassis 218 may be supported by a set of tires 228, and the wing booms may be supported by smaller wheels 230. Primary and secondary distribution lines 232 and 233, respectively, may be flow coupled to the primary and secondary fluid tanks 216 and 217, respectively, in order to provide field spraying capability similar to the field spraying system 10 described above with respect to FIG 1.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

What is claimed is:

1. A nozzle wear out detection system comprising:
a spray nozzle assembly providing an outlet for discharging fluid;
a microphone positioned proximal to the outlet, the microphone being configured to communicate acoustic data corresponding to a discharge of fluid at the outlet;
a data structure holding a baseline calibration measurement corresponding to a discharge of fluid at the outlet, the baseline calibration measurement being derived from acoustic data provided by the microphone at an initial time; and
a controller in communication with the microphone and the data structure, the controller being configured to receive a flow measurement corresponding to a discharge of fluid at the outlet, the flow measurement being derived from acoustic data provided by the microphone at a subsequent time,
wherein the controller compares the flow measurement to the baseline calibration measurement to determine an error.

2. The nozzle wear out detection system of claim 1, wherein the controller is further configured to generate an alert when the error is greater than a predetermined tolerance.

3. The nozzle wear out detection system of claim 2, wherein the error indicates a worn spray nozzle assembly.

4. The nozzle wear out detection system of claim 2, wherein the baseline calibration measurement corresponds to a substantially new spray nozzle assembly.

5. The nozzle wear out detection system of claim 2, wherein the alert is visually displayed to an operator of a machine.

6. The nozzle wear out detection system of claim 2, wherein the controller is further configured to periodically compare the flow measurement to the baseline calibration measurement.

7. The nozzle wear out detection system of claim 1, wherein the spray nozzle assembly is one of a plurality of spray nozzle assemblies, and the data structure holds a plurality of baseline calibration measurements corresponding to a discharge of fluid for each of the plurality spray nozzle assemblies.

8. The nozzle wear out detection system of claim 7, wherein the controller is further configured to receive flow measurements corresponding to a discharge of fluid for each of the plurality of spray nozzle assemblies, and to compare the flow measurement to the baseline calibration measurements to determine a plurality of errors.

9. A method for determining a worn spray nozzle assembly comprising:
(a) discharging fluid from an outlet of a spray nozzle assembly;
(b) holding a baseline calibration measurement corresponding to a discharge of fluid at the outlet, the baseline calibration measurement being derived from acoustic data provided by a microphone at an initial time;
(c) receiving a flow measurement corresponding to a discharge of fluid at the outlet, the flow measurement being derived from acoustic data provided by the microphone at a subsequent time; and
(d) comparing the flow measurement to the baseline calibration measurement to determine an error at a subsequent time.

10. The method of claim 9, further comprising generating an alert when the error is greater than a predetermined tolerance.

11. The method of claim 10, further comprising the error indicating a worn spray nozzle assembly.

12. The method of claim 10, further comprising the baseline calibration measurement corresponding to a substantially new spray nozzle assembly.

13. The method of claim 10, further comprising visually displaying the alert is to an operator of a machine.

14. The method of claim 10, further comprising periodically comparing the flow measurement to the baseline calibration measurement.

15. The method of claim 9, wherein the spray nozzle assembly is one of a plurality of spray nozzle assemblies, and further comprising holding a plurality of baseline calibration measurements corresponding to a discharge of fluid for each of the plurality spray nozzle assemblies.

16. The method of claim 15, further comprising receiving flow measurements corresponding to a discharge of fluid for each of the plurality of spray nozzle assemblies, and comparing the flow measurement to the baseline calibration measurements to determine a plurality of errors.

17. A self-propelled sprayer comprising:
an operator cab supported by a chassis;
a wing boom supporting by the chassis, the wing boom including a plurality of spray nozzle assemblies, each spray nozzle assembly providing an outlet for discharging fluid;
a plurality of microphones, each microphone being positioned proximal to an outlet, each microphone being configured to communicate acoustic data corresponding to a discharge of fluid at an outlet;
a data structure holding a plurality of baseline calibration measurement corresponding to a discharge of fluid at an outlet, the plurality of baseline calibration measurement being derived from acoustic data provided by the plurality of microphones at an initial time; and
a controller in communication with the plurality of microphone and the data structure, the controller being configured to receive flow measurements corresponding to a discharge of fluid for each of the plurality of spray nozzle assemblies, the flow measurements being derived from acoustic data provided by the plurality of microphone at a subsequent time,
wherein the controller compares the flow measurements to the plurality of baseline calibration measurements to determine a plurality of errors, and the plurality of errors indicates a plurality of worn spray nozzle assemblies.

18. The nozzle flow detection system of claim 17, wherein the controller is further configured to generate an alert when at least one of the plurality of errors is greater than a predetermined tolerance.

19. The nozzle flow detection system of claim 18, wherein the alert is visually displayed in the operator cab.

20. The nozzle flow detection system of claim 18, wherein the controller is further configured to periodically compare the flow measurements to the plurality of baseline calibration measurements.
